(19) United States
(12) Patent Application Publication
(10) Pub. No.: US 2020/0173185 A1
(43) Pub. Date: Jun. 4, 2020

(54) DECK AND HOIST FOR USE IN CONSTRUCTION

(71) Applicant: Eric Snell, Aberdeen, WA (US)

(72) Inventor: Eric Snell, Aberdeen, WA (US)

(21) Appl. No.: 16/786,720

(22) Filed: Feb. 10, 2020

Related U.S. Application Data
(63) Continuation-in-part of application No. 15/942,315, filed on Mar. 30, 2018.
Application No. 15/942,315 is a continuation-in-part of application No. 14/719,073, filed on May 21, 2015, now Pat. No. 10,106,995.
(60) Provisional application No. 62/127,080, filed on Mar. 2, 2015.
(60) Provisional application No. 62/155,866, filed on May 1, 2015.

(51) Int. Cl. E04G 21/16; B66C 1/10; E04G 21/32; B66C 23/82; B66C 23/26

(52) U.S. Cl. CPC E04G 21/166; B66C 1/10; B66C 23/26; B66C 23/82; E04G 21/3223

(57) ABSTRACT

A deck for use in construction, the deck comprising: a stationary support structure including at least a first box tube and a second box tube disposed parallel to the first box tube, the stationary support structure being positionable entirely within an edge of a floor of a building; a bottom plate extending between said first box tube and said second box tube; a first extension member disposed within the first box tube and being operable to retractably extend from the first box tube; a second extension member disposed within the second box tube and being operable to retractably extend from the second box tube; and a platform having one or more wheel structures located along one or more sides of the platform, wherein the one or more wheel structures are comprised of a wheel mount and one or more wheels and the one or more wheels are configured to roll along a top surface of the first box tube and/or a top surface of the second box tube, and wherein the platform is operable to retractably extend at least partly beyond the edge of the floor in conjunction with the first extension member and the second extension member.

### PRIORITY CLAIM

This application is a continuation-in-part of U.S. patent application Ser. No. 15/942,315 filed Mar. 30, 2018, which claims priority to U.S. patent application Ser. No. 14/719,073 filed May 21, 2015 which claims priority to and/or the benefit of U.S. provisional patent application Ser. No. 62/127,080 filed Mar. 2, 2015 and U.S. provisional patent application Ser. No. 62/155,866 filed May 1, 2015. The foregoing applications are incorporated by reference in their entirety as if fully set forth herein.

### FIELD OF THE INVENTION

This invention relates generally to a deck and hoist for use in construction.

### SUMMARY

This invention relates generally to a deck and hoist for use in construction. For example, the deck can be placed near an edge of a floor of a building under construction such that a slidable platform attached to the deck can be extended out beyond the edge of the floor of the building and a load can be placed on the slidable platform, which can then be retracted into the floor of the building. The hoist component, for example, may be placed on a floor of the building, including the top floor, so that it can lift loads and place them on the slidable platforms of the decks. The slidable platform can be extended beyond the edge of the floor to facilitate access to the load by a hoist, lift, crane, or other similar system. Alternatively, the slidable platform can be extended beyond the edge of the floor to receive a load from a hoist, lift, crane, or other similar system. The slidable platform can then be retracted within the edge of the floor to facilitate removal of the load onto the floor. This deck and slidable platform can improve safety because the slidable platform and the deck can be maintained substantially entirely within the edge of the floor when not in use so as to limit their interference. The deck and slidable platform also improve efficiency because a crane, hoist, or other lifting method would not have to be built to avoid the decks, and instead can lift anywhere along the side of a building; any decks that would interfere with the lifting means can be retracted in order to avoid such interference. Furthermore, the design of the deck and platform can increase the amount of weight the platform can carry and also limit the need for shore posts. This can permit the deck and slidable platform to be used in situations where there is no top structure, such as on a roof, or when the top structure has limited strength. Other uses of the deck and slidable platform are possible. For example, the deck and slidable platform can be used proximate to a hole instead of a near a building edge. The deck and slidable platform are not limited to building construction either, and could be utilized in underground or above-ground mining operations, with rock faces or scaffolding functioning as the floor of a building. Furthermore, the deck and platform can include additional structures as disclosed herein, such as an integrated hoist and/or a basket that can include an integrated version of the deck. The slidable platform can include a hoist and basket device wherein the hoist and basket are comprised of a predominantly rectangular basket with a connection mechanism on a top side allowing it to be connected to a hoist attached to the deck. The hoist device can also potentially include a deck, and in some embodiments the frame of the hoist device would be configured to be modular, such that the stationary support structure that runs parallel to the ground would be composed of one or more segments where adding additional segments increases the length of the stationary support structure. In some embodiments, the hoist device may be modular, such that the frame can be disassembled into smaller, portable components.

In one embodiment, a deck for use in construction is provided, the deck including, but not being limited to, a stationary support structure that is positionable on a floor of a building, the stationary support structure including at least: a first box tube; a second box tube disposed substantially parallel to the first box tube; a plate that extends between the first box tube and the second box tube; and at least one hydraulic cylinder mounted on the plate; a first extension member that is slidably disposed within the first box tube; a second extension member that is slidably disposed within the second box tube; a beam that extends between the first and second extension members, the beam coupled to the at least one hydraulic cylinder; and a platform that is detached from the first box tube and the second box tube and that is coupled to the beam, the platform wherein the platform is comprised of two or more roller wheels positioned along its side edges such that the roller wheels roll along the top surface of the first box tube and second box tube respectively, wherein the platform is operable to retractably extend beyond an edge of the floor in conjunction with the first and second extension members in response to actuation of the at least one hydraulic cylinder.

In another embodiment, the deck further includes, but is not limited to, at least one scale associated with the platform.

In another embodiment, the deck further includes, but is not limited to, at least one shore post that extends from the stationary support structure and can be configured to extend up to a ceiling or scaffold above the deck to provide counter-force against weight placed on a deck.

In another embodiment, the deck further includes, but is not limited to, at least one counterweight receptacle coupled to the stationary support structure that is operable to removably receive one or more counterweights. In some embodiments, the counterweight receptacle may be integrated into the stationary support structure.

In another embodiment, the deck further includes, but is not limited to, one or more removable counterweights.

In another embodiment, the deck further includes, but is not limited to, a fold-away ramp coupled to the stationary support structure that is operable to facilitate transfer of one or more loads with respect to the platform.

In another embodiment, the deck further includes, but is not limited to, at least one guard rail associated with the platform. In some embodiments the guard rail (or rails) may also be separated into two or more pieces that can be swung or slid away from each other to create a temporary door.

In another embodiment, the deck further includes, but is not limited to, a hoist mounted on the stationary support structure such that the hoist is operable to project from inside the edge of the floor to a point beyond the edge of the floor for lifting one or more loads.

In another embodiment, the deck further includes, but is not limited to, at least one scale associated with the hoist.

In another embodiment, the deck further includes, but is not limited to, a hoist including at least a mast mounted on the stationary support structure and at least one boom that projects from the mast or the stationary support structure.

In another embodiment, the deck further includes, but is not limited to, a hoist including at least a luffing device that extends from the mast to the at least one boom for adjusting pitch or angle of the at least one boom.

In another embodiment, the deck further includes, but is not limited to, a luffing device including at least one of a hydraulic cylinder or a cable. In such embodiments the cylinder or cable may be the last structure before the hoist's line, or it may be integrated into a stabilization structure for the hoist.

In another embodiment, the deck further includes, but is not limited to, a hoist including at least a winch; a sheave; a cable that extends from the winch over the sheave; and an overhaul ball coupled to the cable.

In another embodiment, the deck further includes, but is not limited to, a hoist that is height adjustable relative to the stationary support structure.

In another embodiment, the deck further includes, but is not limited to, a hoist is position adjustable along a length of the stationary support structure.

In another embodiment, the deck further includes, but is not limited to, a hoist is removably mounted on the stationary support structure.

In one embodiment, a deck for use in construction is provided, the deck including, but not limited to, a stationary support structure that is positionable on a floor of a building, the stationary support structure including at least: a first box tube; a second box tube disposed substantially parallel to the first box tube; a plate that extends between the first box tube and the second box tube; at least one hydraulic cylinder mounted on the plate; and at least one counterweight receptacle; a first extension member that is slidably disposed within the first box tube; a second extension member that is slidably disposed within the second box tube; a beam that extends between the first and second extension members, the beam coupled to the at least one hydraulic cylinder; a platform that is detached from the first box tube and the second box tube and that is coupled to the beam, the platform including at least one wheel operable to roll on the first box tube or second box tube for distributing at least some weight from the platform to the floor of the building, wherein the platform is operable to retractably extend beyond an edge of the floor in conjunction with the first and second extension members in response to actuation of the at least one hydraulic cylinder; and a hoist mounted on the stationary support structure such that the hoist is operable to project from inside the edge of the floor to a point beyond the edge of the floor for lifting one or more loads.

In one embodiment a deck for use in construction is provided, the deck including, but not limited to at least one fixed member positionable on a floor of a building, the at least one fixed member including at least one drive mechanism coupled thereto or disposed therein; at least one extension member that is coupled to the at least one drive mechanism, the at least one extension member operable to retractably extend from the at least one fixed member beyond an edge of the floor in response to actuation of the at least one drive mechanism; and a platform that is detached from the at least one fixed member and that is coupled to the at least one extension member such that the platform is operable to retractably extend beyond the edge of the floor in conjunction with the at least one extension member, the platform including at least one wheel operable to either interface directly or indirectly with the floor of the building for distributing at least some weight from the platform to the floor of the building or for interfacing directly or indirectly with the fixed member.

In one embodiment, a method for making a deck for use in construction includes, but is not limited to, positioning a first box tube substantially parallel to a second box tube; attaching a plate to the first box tube and the second box tube, the plate extending between the first box tube and the second box tube; coupling a hydraulic cylinder to the plate; slidably inserting a first extension member at least partially into the first box tube; slidably inserting a second extension member at least partially into the second box tube, the first and second extension members having a beam extending therebetween; coupling the hydraulic cylinder to the beam; positioning a platform having one or more wheels on the plate and over the hydraulic cylinder such that the platform is rollable relative to the plate; and attaching the platform to the beam such that the platform is operable to retractably extend beyond an edge of a floor of a building in conjunction with the first and second extension members in response to actuation of the at least one hydraulic cylinder. In some embodiments the hydraulic cylinder may be replaced with another motor such as an electrically powered chain motor, or such other motor as may be appropriate.

In one embodiment, a deck for use in construction is provided, the deck including, but not limited to, a stationary support structure that is positionable on a floor of a building; at least one extension member that is operable to retractably extend from the stationary support structure; and a platform that includes one or more wheels for interfacing directly or indirectly with the floor or stationary support structure, and that is coupled to the at least one extension member, wherein the platform is operable to retractably extend beyond an edge of the floor in conjunction with the at least one extension member.

For some examples of the invention, the platform is further comprised of roller wheels that may be located on the side(s) of the platform and configured to roll along the tops of the box tubes, such that the weight of the load is at least partially placed on said wheels instead of a wheel beneath the platform. In some embodiments there may be a wear-pad or other track built onto the top of the box tubes to facilitate such movement. The wheels may be a variety of configurations, and in some variations may be motorized or otherwise powered. The wheels may be located in wheel structures that facilitate in their positioning, and said wheels and/or wheel structures may be located anywhere along the platform, emerging upward to reach the higher box tubes if necessary. In some embodiments the wheels and/or wheel structures are located on the side of the platform at the rear, while in others they may be located in the middle of the sides, the front of the sides, or any configuration thereof, including being located at various other positions along said sides. In some embodiments, the wheels might be spheres located in case that leaves some of the sphere exposed, allowing them to roll in any chosen direction. In some embodiments, the wheels may be configured to be removably coupled to the platform, and may be removed if no longer needed, repositioned to adjust weight loads, and/or for transit purposes.

The invention may, in some examples, be comprised of additional roller wheels that stabilize the deck platform by rolling along the inner-facing sides of the first and second box tubes. In some embodiments, the box tubes may have a wear pad on their top or other surfaces to reduce wear on the box tubes from repeated use.

In another embodiment, the deck further includes, but is not limited to, a drive mechanism operable to extend and retract the at least one extension member. Examples of such drive mechanism may include, but are not limited to, a hydraulic cylinder, chain motor and/or gear motor, self-propelled wheel, or a combination thereof. The invention's platform may also further comprise one or more wheels for interfacing directly or indirectly with the floor, or that interface directly with the stationary support structure or bottom plate.

In another embodiment, the deck further includes, but is not limited to, at least one shore post that extends from the stationary support structure.

In another embodiment, the deck further includes, but is not limited to, at least one counterweight receptacle coupled to the stationary support structure that is operable to removably receive one or more counterweights.

In another embodiment, the deck further includes, but is not limited to, one or more removable counterweights.

In another embodiment, the deck further includes, but is not limited to, a fold-away ramp coupled to the stationary support structure that is operable to facilitate transfer of one or more loads with respect to the platform.

In another embodiment, the deck further includes, but is not limited to, at least one guard rail associated with the platform.

In another embodiment, the deck further includes, but is not limited to, a hoist mounted on the stationary support structure such that the hoist is operable to project from inside the edge of the floor to a point beyond the edge of the floor for lifting one or more loads.

In another embodiment, the deck further includes, but is not limited to, a hoist including at least a mast mounted on the stationary support structure; and at least one boom that projects from the mast or the stationary support structure.

In another embodiment, the deck further includes, but is not limited to, a hoist including at least a luffing hydraulic cylinder that extends from the mast to the at least one boom for adjusting pitch or angle of the at least one boom.

In another embodiment, the deck further includes, but is not limited to, a hoist including at least a winch; a sheave; a cable that extends from the winch over the sheave; and an overhaul ball coupled to the cable.

In another embodiment, the deck further includes, but is not limited to, a hoist that is height adjustable relative to the stationary support structure.

In another embodiment, the deck further includes, but is not limited to, a hoist that is position adjustable along a length of the stationary support structure.

In another embodiment, the deck further includes, but is not limited to, a hoist that is removably mounted on the stationary support structure.

In another embodiment, the deck further includes, but is not limited to, a hoist that may be attached to the deck or elsewhere and is connected to a basket system.

In another embodiment, the basket system is comprised of a rectangular cuboid that can be connected to the hoist by attachment points at its top corners.

In another embodiment, the basket system has a door on a front, rear or side face.

In another embodiment, the basket system has a slidable platform on its floor configured to interface with a deck.

In one embodiment, a deck for use in construction is provided, the deck including, but not limited to, a stationary support structure that is positionable on a floor of a building and that includes at least one counterweight receptacle; at least one extension member that is operable to retractably extend from the stationary support structure; a platform that includes one or more wheels for interfacing directly or indirectly with the floor and that is coupled to the at least one extension member, wherein the platform is operable to retractably extend beyond an edge of the floor in conjunction with the at least one extension member; and a hoist mounted on the stationary support structure such that the hoist is operable to project from inside the edge of the floor to a point beyond the edge of the floor for lifting one or more loads.

In one embodiment, a technique for use in construction is provided, the technique including, but not limited to, positioning a deck on a floor of a building, the deck including at least a stationary support structure and a slidable platform; and extending the slidable platform relative to the stationary support structure beyond an edge of the floor of the building at least partly using one or more wheels of the slidable platform that rest directly or indirectly on the floor of the building.

In one embodiment, a hoist for use in construction is provided, the hoist including, but not limited to a stationary support structure; a mast mounted on the stationary support structure; at least one boom that projects from the stationary support structure or the mast; and a platform slidable relative to the stationary support structure for receiving or delivery one or more loads, wherein the hoist is operable to project from inside an edge of a floor of a building to a point beyond the edge of the floor for lifting or depositing the one or more loads with respect to the platform.

In another embodiment, the hoist includes, but is not limited to, at least one shore post that extends from the stationary support structure.

In another embodiment, the hoist includes, but is not limited to, at least one counterweight receptacle coupled to the stationary support structure that is operable to removably receive one or more counterweights.

In another embodiment, the hoist includes, but is not limited to, one or more removable counterweights.

In another embodiment, the hoist includes, but is not limited to, a ramp coupled to the stationary support structure that is operable to facilitate transfer of one or more loads.

In another embodiment, the hoist includes, but is not limited to, at least one guard rail associated with the stationary support structure.

In another embodiment, the hoist includes, but is not limited to, a winch; a sheave; a cable that extends from the winch over the sheave; and an overhaul ball coupled to the cable.

In another embodiment, the hoist includes, but is not limited to, the mast being height adjustable.

In another embodiment, the hoist includes, but is not limited to, the mast being position adjustable.

In another embodiment, the hoist includes, but is not limited to, the mast being removable.

In another embodiment, the hoist includes, but is not limited to, at least one back brace that extends from the mast to the stationary support structure.

In another embodiment, the hoist includes, but is not limited to, at least one front brace that extends from the mast to the boom.

In another embodiment, the hoist includes, but is not limited to, wherein the at least one front brace is fixed.

In another embodiment, the hoist includes, but is not limited to, wherein the at least one front brace includes a hydraulic cylinder for adjusting pitch or angle of the boom.

In another embodiment, the hoist includes, but is not limited to, a removably connected basket system that can be raised or lowered by the hoist.

In another embodiment, the hoist includes, but is not limited to, a basket system wherein the hoist is connected to the four corners of the top face of the basket system.

In another embodiment, the hoist includes, but is not limited to, at least one front brace including a hydraulic cylinder for adjusting pitch or angle of the boom, the hydraulic cylinder being programmed to stop at one or more pre-specified positions.

In another embodiment, the hoist includes, but is not limited to, at least one hydraulic cylinder coupled to the stationary support structure and the platform.

In another embodiment, the hoist includes, but is not limited to, a stationary support structure that comprises a first beam; a second beam disposed substantially parallel to the first beam; a plate that extends between the first beam and the second beam; and at least one hydraulic cylinder mounted on the plate.

In another embodiment, the hoist includes, but is not limited to, wherein the stationary support structure comprises a first beam; a second beam disposed substantially parallel to the first beam; a plate that extends between the first beam and the second beam; at least one hydraulic cylinder mounted on the plate, a first extension member that is slidably disposed on or in the first beam; and a second extension member that is slidably disposed on or in the second beam, the first and second extension members having a cross-beam extending therebetween, the at least one hydraulic cylinder coupled to the cross-beam, wherein the platform is coupled to the cross-beam and wherein the platform is operable to retractably extend in response to actuation of the at least one hydraulic cylinder.

In one embodiment, a hoist for use in building construction is provided, the hoist including, but not limited to, a stationary support structure positionable on a floor of a building; a lift coupled to the stationary support structure; and a platform slidable relative to the stationary support structure at least partly using one or more rollers or wheels operable to interface directly or indirectly with the floor, wherein the lift is operable to project from inside an edge of the floor of the building to a point beyond the edge of the floor for lifting or depositing one or more loads with respect to the platform.

In some examples of the deck and hoist, the deck may be coupled to a stationary support structure positionable on the floor of a building, and said support structure may be comprised of a number of support units that can be combined to increase the length and/or area of the stationary support structure, and/or make it easier to transport in smaller pieces. For example, the stationary support structure may be comprised of a number of square brackets with support beams attached at two adjacent corners of the brackets and extending to the middle of the side of the bracket opposite the corner's shared side.

### BRIEF DESCRIPTION OF THE DRAWINGS

Embodiments of the present invention are described in detail below with reference to the following drawings:

FIG. 1 is a perspective view of a deck and hoist, in accordance with an embodiment of the invention;

FIG. 2 is a top view of a deck and hoist, in accordance with an embodiment of the invention;

FIG. 3 is a side view of a deck and hoist, in accordance with an embodiment of the invention;

FIG. 4 is a front view of a deck and hoist, in accordance with an embodiment of the invention;

FIG. 5 is a bottom view of a deck and hoist, in accordance with an embodiment of the invention;

FIG. 6 is a perspective view of a deck and hoist, in accordance with an embodiment of the invention;

FIG. 7 is a perspective view of a deck and hoist, in accordance with an embodiment of the invention;

FIG. 8 is a top view of a deck and hoist, in accordance with an embodiment of the invention;

FIG. 9 is a side view of a deck and hoist, in accordance with an embodiment of the invention;

FIG. 10 is a front view of a deck and hoist, in accordance with an embodiment of the invention;

FIG. 11 is a bottom view of a deck and hoist, in accordance with an embodiment of the invention;

FIG. 12 is a perspective view of a deck and hoist, in accordance with an embodiment of the invention;

FIG. 13 is a perspective view of a deck, in accordance with an embodiment of the invention;

FIG. 14 is a top view of a deck, in accordance with an embodiment of the invention;

FIG. 15 is a side view of a deck, in accordance with an embodiment of the invention;

FIG. 16 is a front view of a deck, in accordance with an embodiment of the invention;

FIG. 17 is a bottom view of a deck, in accordance with an embodiment of the invention;

FIG. 18 is a perspective view of a deck and hoist in operation, in accordance with an embodiment of the invention;

FIG. 19 is a perspective view of a deck and hoist, in accordance with an embodiment of the invention;

FIG. 20 is a top view of a deck and hoist, in accordance with an embodiment of the invention;

FIG. 21 is a side view of a deck and hoist, in accordance with an embodiment of the invention;

FIG. 22 is a front view of a deck and hoist, in accordance with an embodiment of the invention;

FIG. 23 is a bottom view of a deck and hoist, in accordance with an embodiment of the invention;

FIG. 24 is a perspective view of a deck, in accordance with an embodiment of the invention; and

FIG. 25 is a perspective view of a set of in use, in accordance with an embodiment of the invention.

### DETAILED DESCRIPTION

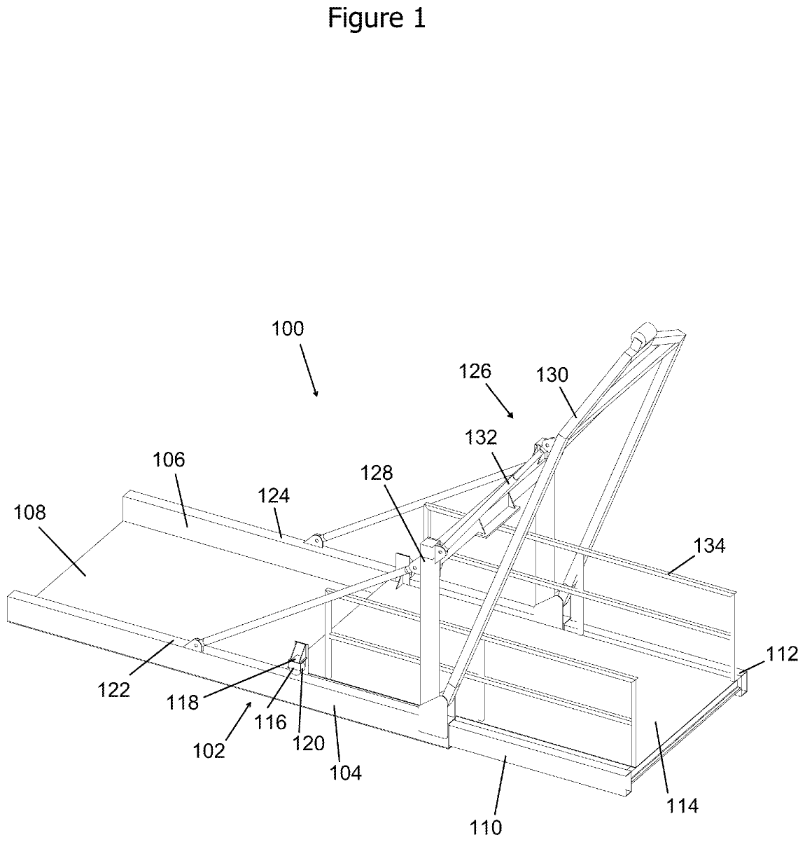

This invention relates generally to a method for making a deck for use in construction. Specific details of certain embodiments of the invention are set forth in the following description and in FIGS. 1-25 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of a deck, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member 110 disposed within the first box tube 104 and being operable to retractably extend from the first box tube 104; a second extension member 112 disposed within the second box tube 106 and being operable to retractably extend from the second box tube 106; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface 122 of the first box tube 104 and/or a top surface 124 of the second box tube 106, and wherein the platform 114 is operable to retractably extend at least partly beyond the edge of the floor in conjunction with the first extension member 110 and the second extension member 112.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure 102 or bottom plate 108.

In another embodiment, the deck 100 further includes, but is not limited to, at least one guard rail 134 associated with the platform 114.

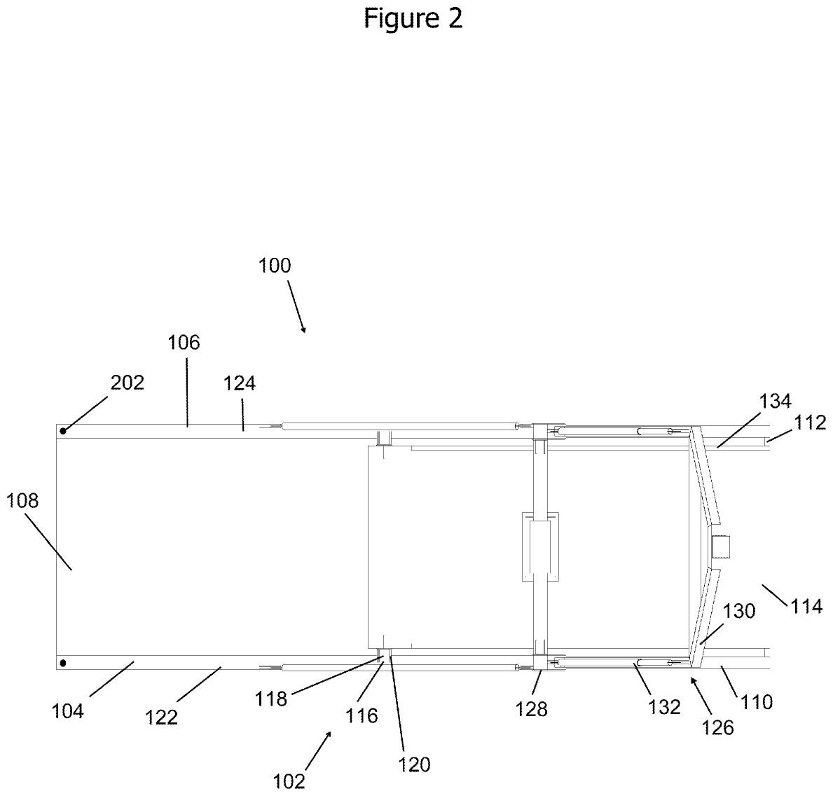

FIG. 2 is a top view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member 110 disposed within the first box tube 104 and being operable to retractably extend from the first box tube 104; a second extension member 112 disposed within the second box tube 106 and being operable to retractably extend from the second box tube 106; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface 122 of the first box tube 104 and/or a top surface 124 of the second box tube 106, and wherein the platform 114 is operable to retractably extend at least partly beyond the edge of the floor in conjunction with the first extension member 110 and the second extension member 112.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure 102 or bottom plate 108.

In another embodiment, the deck 100 further includes, but is not limited to, at least one guard rail 134 associated with the platform 114.

In another embodiment, the deck 100 further includes, but is not limited to, at least one shore post hole 202 for receiving a shore post that extends from the stationary support structure 102 and can be configured to extend up to a ceiling or scaffold above the deck 100 to provide counter-force against weight placed on a deck.

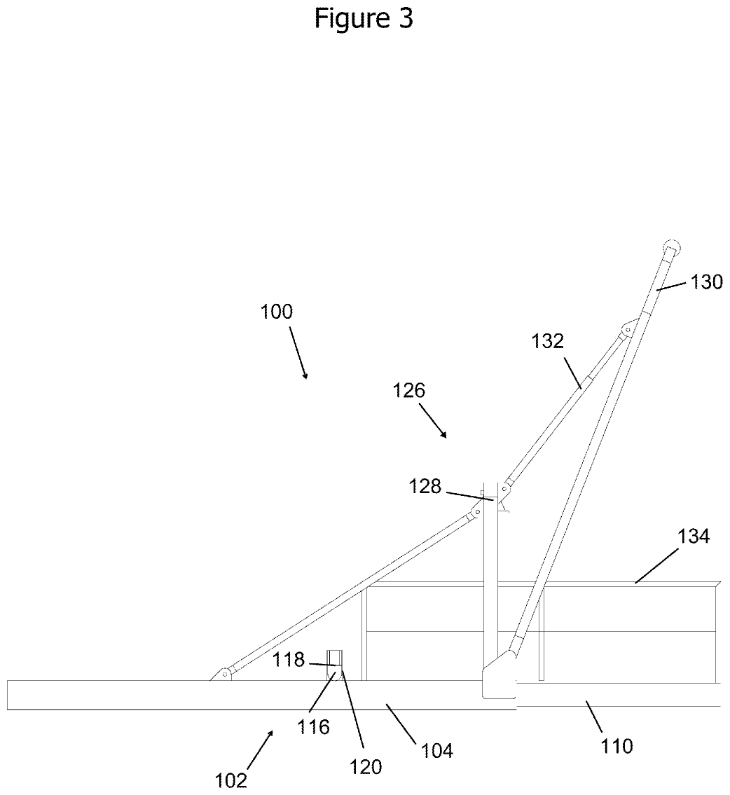

FIG. 3 is a side view of a deck and hoist, in accordance with an embodiment of the invention.

A deck 100 for use in construction, the deck 100 comprising: a stationary support structure 102 including at least a first box tube 104 and a second box tube disposed parallel to the first box tube 104, the stationary support structure 102 being positionable entirely within an edge of a floor of a building; a bottom plate extending between said first box tube 104 and said second box tube; a first extension member 110 disposed within the first box tube 104 and being operable to retractably extend from the first box tube 104; a second extension member disposed within the second box tube and being operable to retractably extend from the second box tube; and a platform having one or more wheel structures 116 located along one or more sides of the platform and extending away therefrom, wherein the one or more wheel structures 116 are comprised of a wheel mount 118 and one or more wheels 120 and the one or more wheels 120 are configured to roll along a top surface of the first box tube 104 and/or a top surface of the second box tube 106, and wherein the platform 114 is operable to retractably extend at least partly beyond the edge of the floor in conjunction with the first extension member 110 and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110. Examples of such drive mechanism may include, but are not limited to, a hydraulic cylinder, chain motor, self-propelled wheel and/or gear motor, or a combination thereof. The platform may also further comprise one or more wheels for interfacing directly or indirectly with the floor, or that interface directly with the stationary support structure 102 or bottom plate.

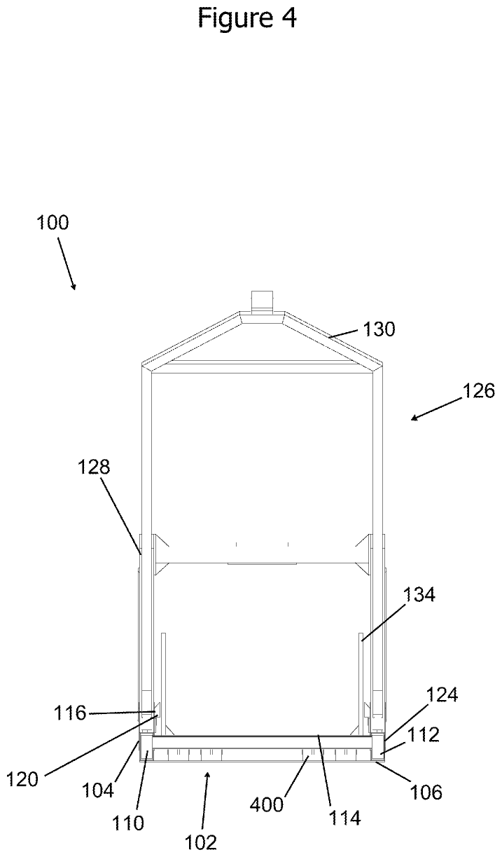

FIG. 4 is a front view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member 110 disposed within the first box tube 104 and being operable to retractably extend from the first box tube 104; a second extension member 112 disposed within the second box tube 106 and being operable to retractably extend from the second box tube 106; and a platform 114 having one or more wheel structures 116 located along one or more sides of the platform 114 and extending away therefrom, wherein the one or more wheel structures 116 are comprised of a wheel mount and one or more wheels 120 and the one or more wheels 120 are configured to roll along a top surface of the first box tube 104 and/or a top surface 124 of the second box tube 106, and wherein the platform 114 is operable to retractably extend at least partly beyond the edge of the floor in conjunction with the first extension member 110 and the second extension member 112.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device that extends from the mast 128 to the at least one boom 130 for adjusting pitch or angle of the at least one boom 130. In another embodiment, the deck 100 further includes, but is not limited to, a luffing device including at least one of a hydraulic cylinder or a cable. In such embodiments the cylinder or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels 400 for interfacing directly or indirectly with the floor, or that interface directly with the stationary support structure 102 or bottom plate 108.

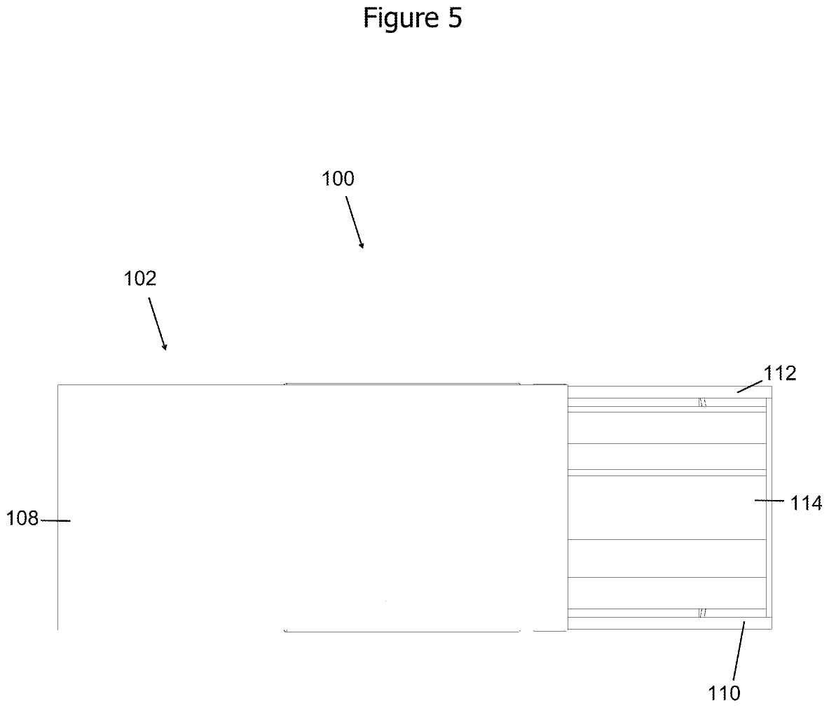

FIG. 5 is a bottom view of a deck and hoist, in accordance with an embodiment of the invention.

A deck 100 for use in construction, the deck 100 comprising: a stationary support structure 102 including at least a first box tube and a second box tube disposed parallel to the first box tube, the stationary support structure 102 being positionable entirely within an edge of a floor of a building; a bottom plate 108 extending between said first box tube and said second box tube; a first extension member 110 disposed within the first box tube and being operable to retractably extend from the first box tube; a second extension member 112 disposed within the second box tube and being operable to retractably extend from the second box tube; and a platform 114 having one or more wheel structures located along one or more sides of the platform 114 and extending away therefrom, wherein the one or more wheel structures are comprised of a wheel mount and one or more wheels and the one or more wheels are configured to roll along a top surface of the first box tube and/or a top surface of the second box tube, and wherein the platform 114 is operable to retractably extend at least partly beyond the edge of the floor in conjunction with the first extension member 110 and the second extension member 112.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure 102 or bottom plate 108.

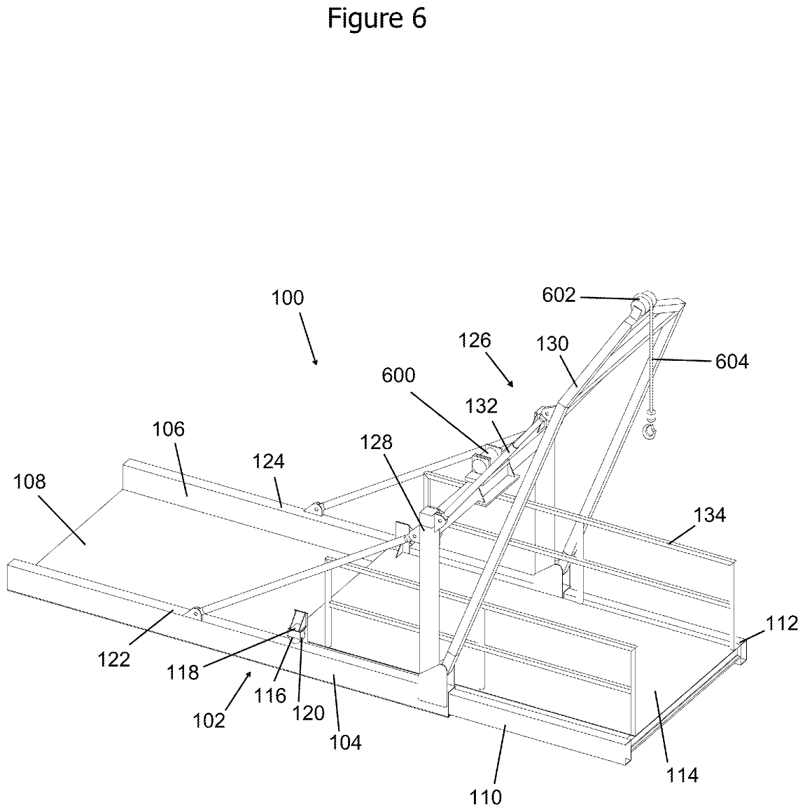

FIG. 6 is a perspective view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member 110 disposed within the first box tube 104 and being operable to retractably extend from the first box tube 104; a second extension member 112 disposed within the second box tube 106 and being operable to retractably extend from the second box tube 106; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface 122 of the first box tube 104 and/or a top surface 124 of the second box tube 106, and wherein the platform 114 is operable to retractably extend at least partly beyond the edge of the floor in conjunction with the first extension member 110 and the second extension member 112.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure 102 or bottom plate 108.

In another embodiment, the deck 100 further includes, but is not limited to, at least one guard rail 134 associated with the platform 114.

In another embodiment, the hoist 126 includes, but is not limited to, a winch 600; a sheave 602; a cable 604 that extends from the winch over the sheave; and an overhaul ball coupled to the cable.

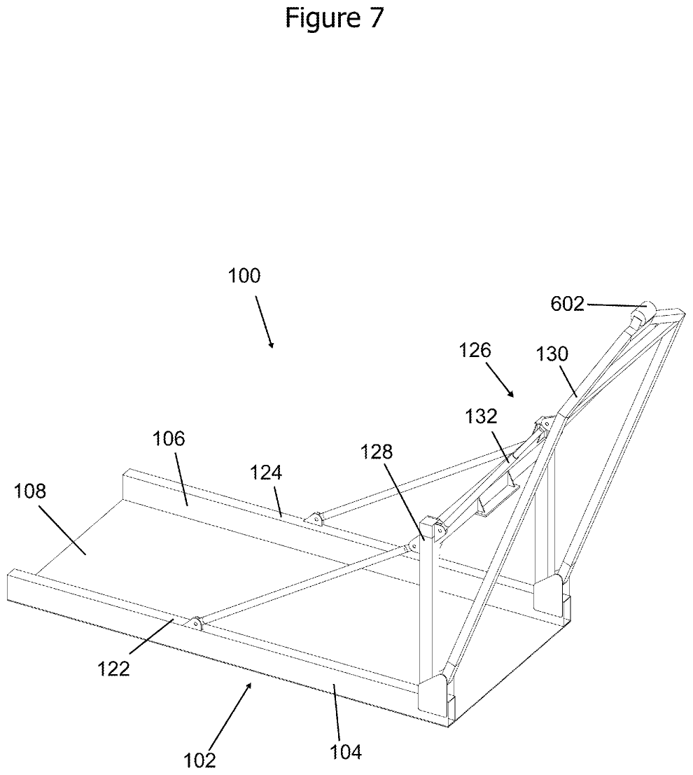

FIG. 7 is a perspective view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the hoist 126 includes, but is not limited to, a winch; a sheave 602; a cable that extends from the winch over the sheave; and an overhaul ball coupled to the cable.

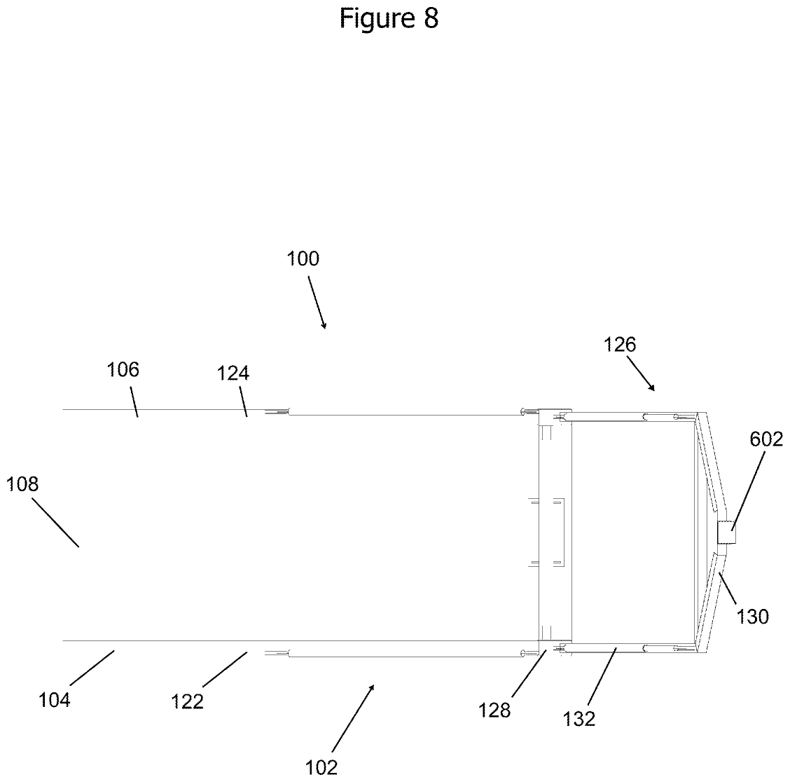

FIG. 8 is a top view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist mounted on the stationary support structure 102 such that the hoist is operable to project from inside the edge of the floor to a point beyond the edge of the floor for lifting one or more loads. In another embodiment, the deck 100 further includes, but is not limited to, a hoist including at least a mast 128 mounted on the stationary support structure 102 and at least one boom 130 that projects from the mast 128 or the stationary support structure 102. In another embodiment, the deck 100 further includes, but is not limited to, a hoist including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's line, or it may be integrated into a stabilization structure for the hoist. In another embodiment, the deck 100 further comprises, but is not limited to, a hoist that is removably mounted on the stationary support structure 102.

In another embodiment, the hoist includes, but is not limited to, a winch; a sheave 602; a cable that extends from the winch over the sheave; and an overhaul ball coupled to the cable.

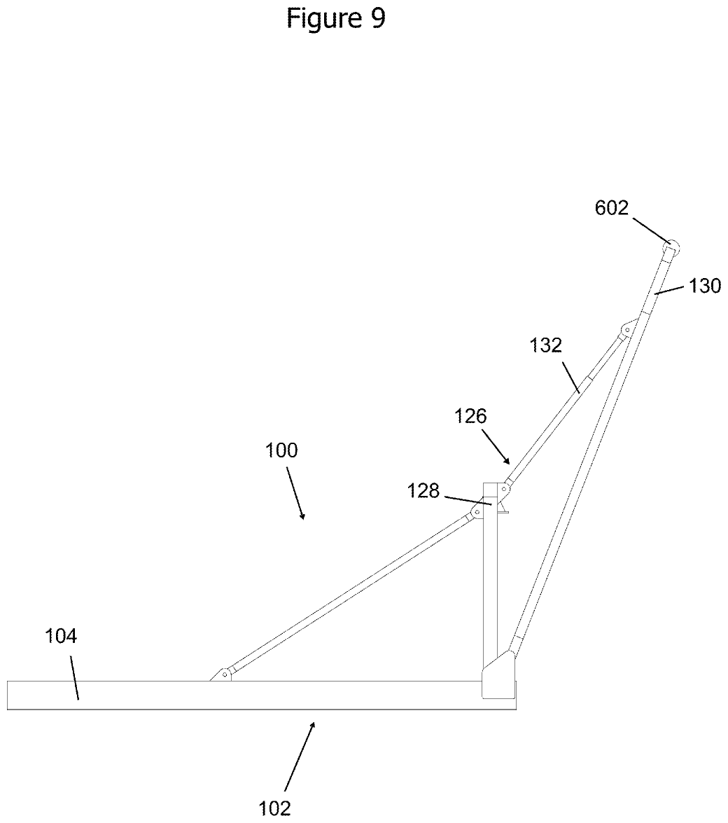

FIG. 9 is a side view of a deck and hoist, in accordance with an embodiment of the invention.

A deck 100 for use in construction, the deck 100 comprising: a stationary support structure 102 including at least a first box tube 104 and a second box tube disposed parallel to the first box tube 104, the stationary support structure 102 being positionable entirely within an edge of a floor of a building; a bottom plate extending between said first box tube 104 and said second box tube; a first extension member disposed within the first box tube 104 and being operable to retractably extend from the first box tube 104; a second extension member disposed within the second box tube and being operable to retractably extend from the second box tube; and a platform having one or more wheel structures located along one or more sides of the platform and extending away therefrom, wherein the one or more wheel structures are comprised of a wheel mount and one or more wheels and the one or more wheels are configured to roll along a top surface of the first box tube 104 and/or a top surface of the second box tube, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the hoist 126 includes, but is not limited to, a winch; a sheave 602; a cable that extends from the winch over the sheave; and an overhaul ball coupled to the cable.

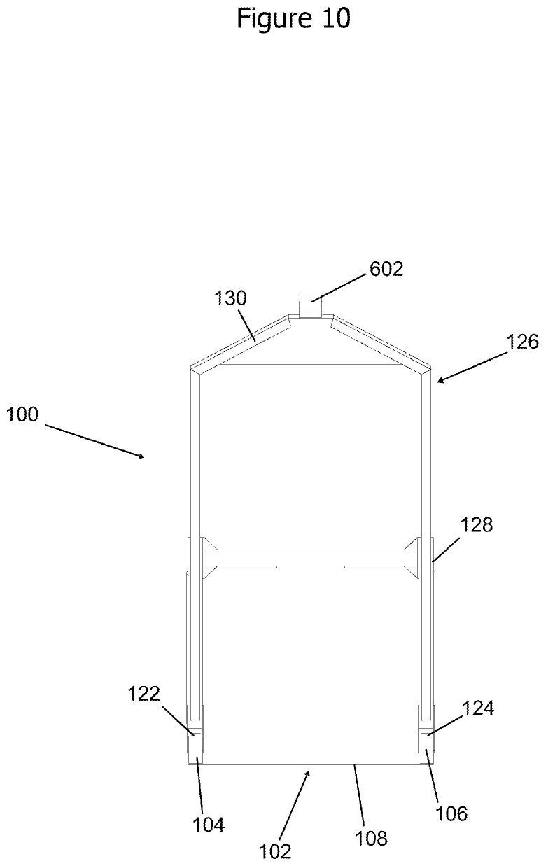

FIG. 10 is a front view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device that extends from the mast 128 to the at least one boom 130 for adjusting pitch or angle of the at least one boom 130. In another embodiment, the deck 100 further includes, but is not limited to, a luffing device including at least one of a hydraulic cylinder or a cable. In such embodiments the cylinder or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the hoist 126 includes, but is not limited to, a winch; a sheave; a cable that extends from the winch over the sheave; and an overhaul ball coupled to the cable.

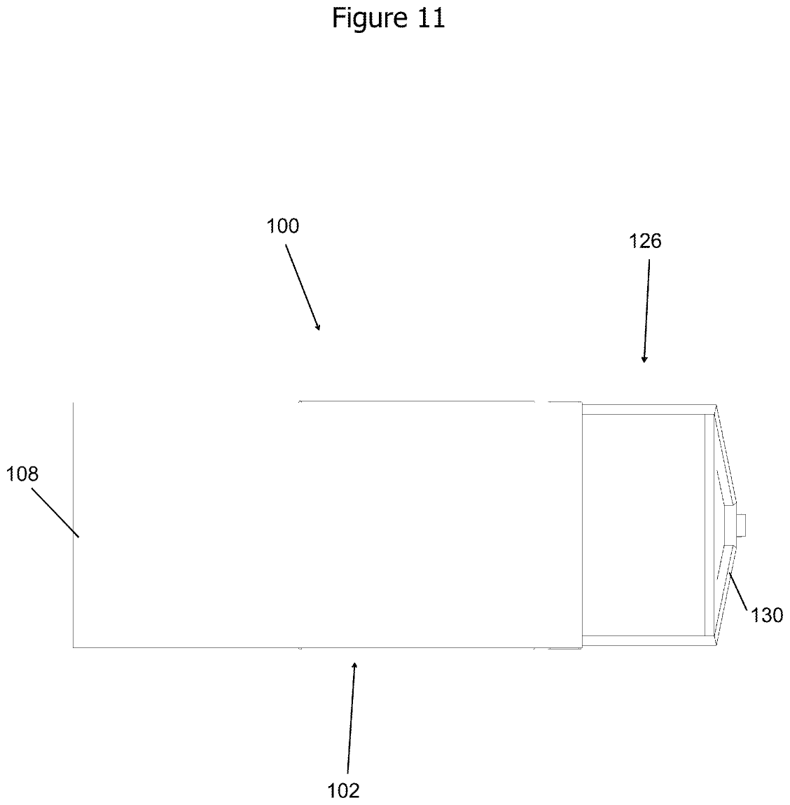

FIG. 11 is a bottom view of a deck and hoist, in accordance with an embodiment of the invention.

A deck 100 for use in construction, the deck 100 comprising: a stationary support structure 102 including at least a first box tube and a second box tube 106 disposed parallel to the first box tube, the stationary support structure 102 being positionable entirely within an edge of a floor of a building; a bottom plate 108 extending between said first box tube and said second box tube; a first extension member disposed within the first box tube and being operable to retractably extend from the first box tube; a second extension member disposed within the second box tube and being operable to retractably extend from the second box tube; and a platform having one or more wheel structures located along one or more sides of the platform and extending away therefrom, wherein the one or more wheel structures are comprised of a wheel mount and one or more wheels and the one or more wheels are configured to roll along a top surface of the first box tube and/or a top surface of the second box tube, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast mounted on the stationary support structure 102 and at least one boom 130 that projects from the mast or the stationary support structure 102. In another embodiment, the deck 100 further includes, but is not limited to, a hoist 126 including at least a luffing device that extends from the mast to the at least one boom 130 for adjusting pitch or angle of the at least one boom 130. In another embodiment, the deck 100 further includes, but is not limited to, a luffing device including at least one of a hydraulic cylinder or a cable. In such embodiments the cylinder or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the hoist 126 includes, but is not limited to, a winch; a sheave; a cable that extends from the winch over the sheave; and an overhaul ball coupled to the cable.

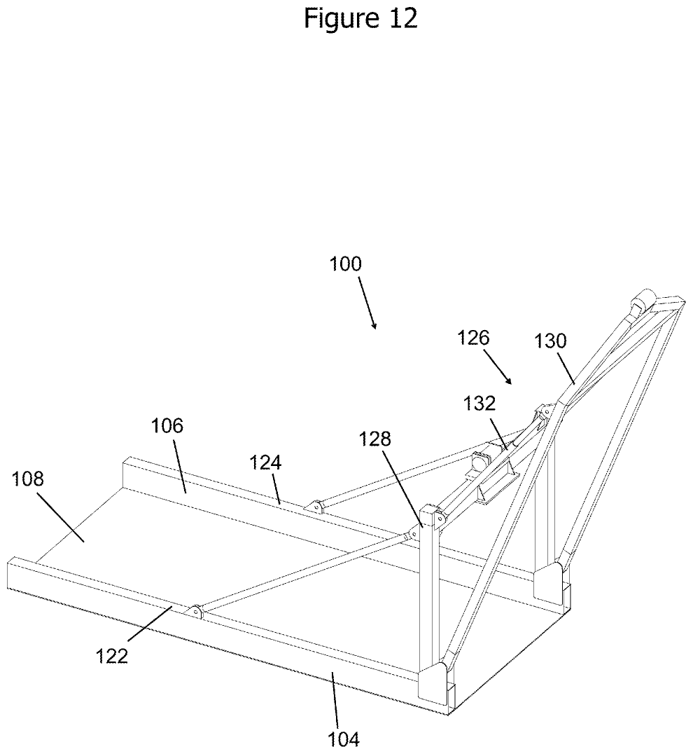

FIG. 12 is a perspective view of a deck and hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the hoist 126 includes, but is not limited to, a winch; a sheave; a cable that extends from the winch over the sheave; and an overhaul ball coupled to the cable.

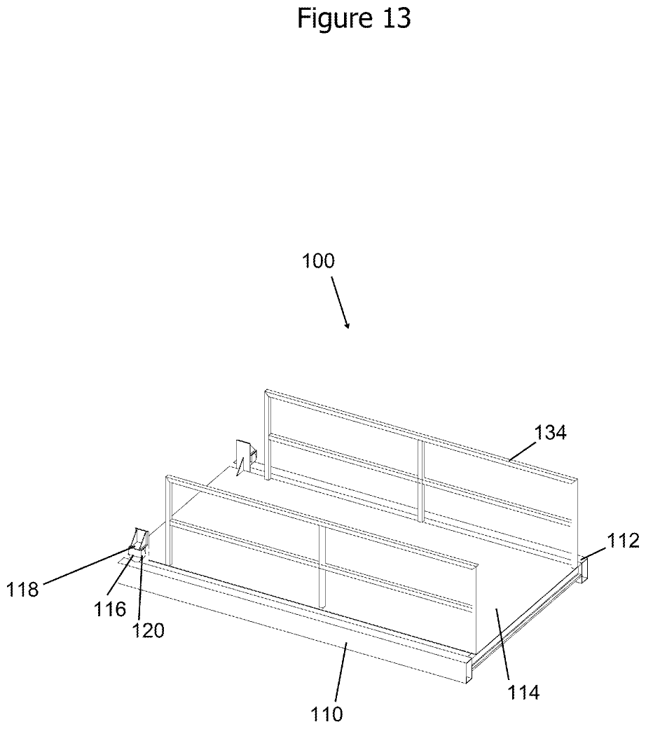

FIG. 13 is a perspective view of a deck, in accordance with an embodiment of the invention.

A deck 100 for use in construction, the deck 100 comprising: a stationary support structure including at least a first box tube and a second box tube disposed parallel to the first box tube, the stationary support structure being positionable entirely within an edge of a floor of a building; a bottom plate extending between said first box tube and said second box tube; a first extension member 110 disposed within the first box tube and being operable to retractably extend from the first box tube; a second extension member 112 disposed within the second box tube and being operable to retractably extend from the second box tube; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface of the first box tube and/or a top surface of the second box tube, and wherein the platform 114 is operable to retractably extend at least partly beyond the edge of the floor in conjunction with the first extension member 110 and the second extension member 112.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure or bottom plate.

In another embodiment, the deck 100 further includes, but is not limited to, at least one guard rail 134 associated with the platform 114.

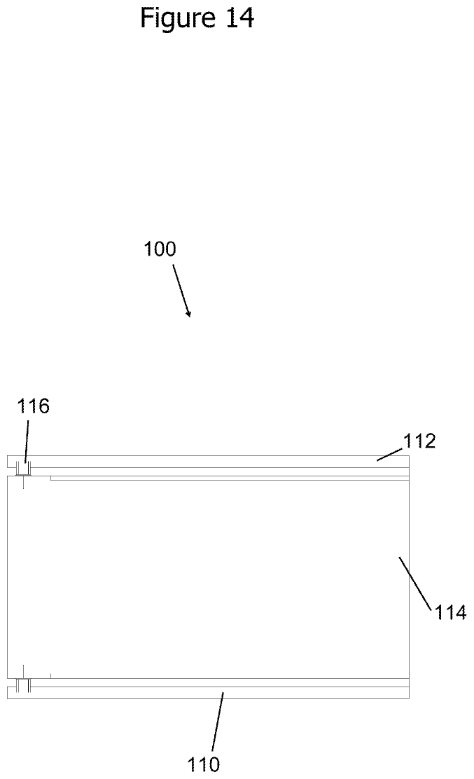

FIG. 14 is a top view of a deck, in accordance with an embodiment of the invention.

A deck 100 for use in construction, the deck 100 comprising: a stationary support structure including at least a first box tube and a second box tube 106 disposed parallel to the first box tube, the stationary support structure being positionable entirely within an edge of a floor of a building; a bottom plate extending between said first box tube and said second box tube; a first extension member 110 disposed within the first box tube and being operable to retractably extend from the first box tube; a second extension member 112 disposed within the second box tube and being operable to retractably extend from the second box tube; and a platform 114 having one or more wheel structures 116 located along one or more sides of the platform 114 and extending away therefrom, wherein the one or more wheel structures 116 are comprised of a wheel mount and one or more wheels and the one or more wheels are configured to roll along a top surface of the first box tube and/or a top surface of the second box tube, and wherein the platform 114 is operable to retractably extend at least partly beyond the edge of the floor in conjunction with the first extension member 110 and the second extension member 112.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure or bottom plate.

In another embodiment, the deck 100 further includes, but is not limited to, at least one guard rail associated with the platform 114.

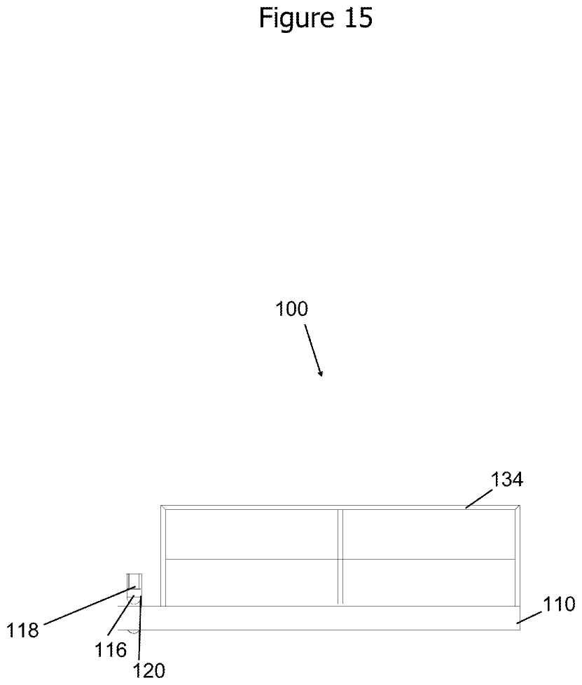

FIG. 15 is a side view of a deck, in accordance with an embodiment of the invention.

A deck 100 for use in construction, the deck 100 comprising: a stationary support structure including at least a first box tube and a second box tube disposed parallel to the first box tube, the stationary support structure being positionable entirely within an edge of a floor of a building; a bottom plate extending between said first box tube and said second box tube; a first extension member 110 disposed within the first box tube and being operable to retractably extend from the first box tube; a second extension member disposed within the second box tube and being operable to retractably extend from the second box tube; and a platform having one or more wheel structures 116 located along one or more sides of the platform and extending away therefrom, wherein the one or more wheel structures 116 are comprised of a wheel mount and one or more wheels 120 and the one or more wheels 120 are configured to roll along a top surface of the first box tube and/or a top surface of the second box tube, and wherein the platform is operable to retractably extend at least partly beyond the edge of the floor in conjunction with the first extension member 110 and the second extension member.

In another embodiment, the deck 100 further includes, but is not limited to, a drive mechanism operable to extend and retract the at least one extension member 110. Examples of such drive mechanism may include, but are not limited to, a hydraulic cylinder, chain motor, self-propelled wheel and/or gear motor, or a combination thereof. The platform may also further comprise one or more wheels for interfacing directly or indirectly with the floor, or that interface directly with the stationary support structure or bottom plate.

In another embodiment, the deck 100 further includes, but is not limited to, at least one guard rail 134 associated with the platform.

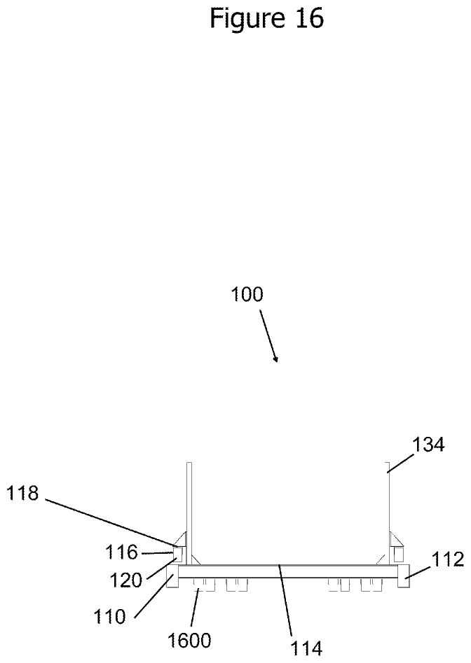

FIG. 16 is a front view of a deck, in accordance with an embodiment of the invention.

A deck 100 for use in construction, the deck 100 comprising: a stationary support structure including at least a first box tube and a second box tube disposed parallel to the first box tube, the stationary support structure being positionable entirely within an edge of a floor of a building; a bottom plate extending between said first box tube and said second box tube; a first extension member 110 disposed within the first box tube and being operable to retractably extend from the first box tube; a second extension member 112 disposed within the second box tube and being operable to retractably extend from the second box tube; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface of the first box tube and/or a top surface of the second box tube, and wherein the platform 114 is operable to retractably extend at least partly beyond the edge of the floor in conjunction with the first extension member 110 and the second extension member 112.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure or bottom plate.

In another embodiment, the deck 100 further includes, but is not limited to, at least one guard rail 134 associated with the platform 114.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor and/or gear motor, self-propelled wheel, or a combination thereof. The invention's platform 114 may also further comprise one or more wheels 400 for interfacing directly or indirectly with the floor, or that interface directly with the stationary support structure or bottom plate.

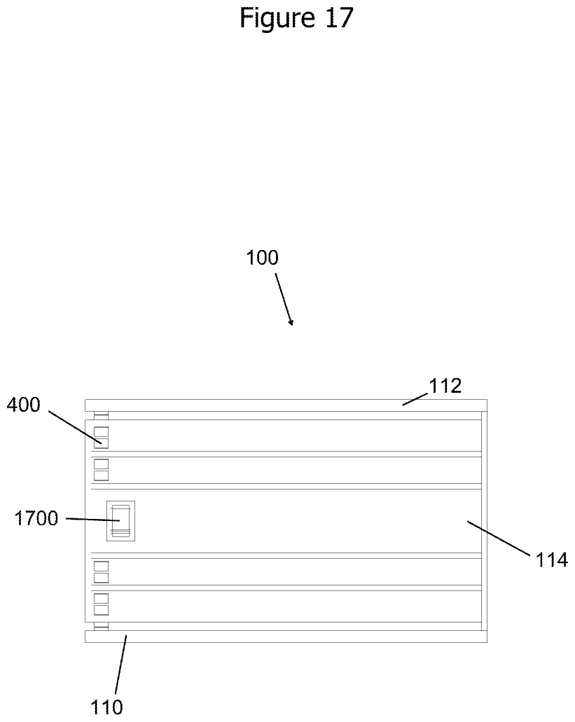

FIG. 17 is a bottom view of a deck, in accordance with an embodiment of the invention.

A deck 100 for use in construction, the deck 100 comprising: a stationary support structure including at least a first box tube and a second box tube disposed parallel to the first box tube, the stationary support structure being positionable entirely within an edge of a floor of a building; a bottom plate extending between said first box tube and said second box tube; a first extension member 110 disposed within the first box tube and being operable to retractably extend from the first box tube; a second extension member 112 disposed within the second box tube and being operable to retractably extend from the second box tube; and a platform 114 having one or more wheel structures located along one or more sides of the platform 114 and extending away therefrom, wherein the one or more wheel structures are comprised of a wheel mount and one or more wheels and the one or more wheels are configured to roll along a top surface of the first box tube and/or a top surface of the second box tube, and wherein the platform 114 is operable to retractably extend at least partly beyond the edge of the floor in conjunction with the first extension member 110 and the second extension member 112.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure or bottom plate.

In another embodiment, the deck 100 further includes, but is not limited to, at least one guard rail associated with the platform 114.

In another embodiment, the deck 100 further includes, but is not limited to, a drive mechanism 1700 operable to extend and retract the at least one extension member 110, 112. Examples of such drive mechanism 1700 may include, but are not limited to, a hydraulic cylinder, chain motor and/or gear motor, self-propelled wheel, or a combination thereof. The invention's platform 114 may also further comprise one or more wheels 400 for interfacing directly or indirectly with the floor, or that interface directly with the stationary support structure or bottom plate.

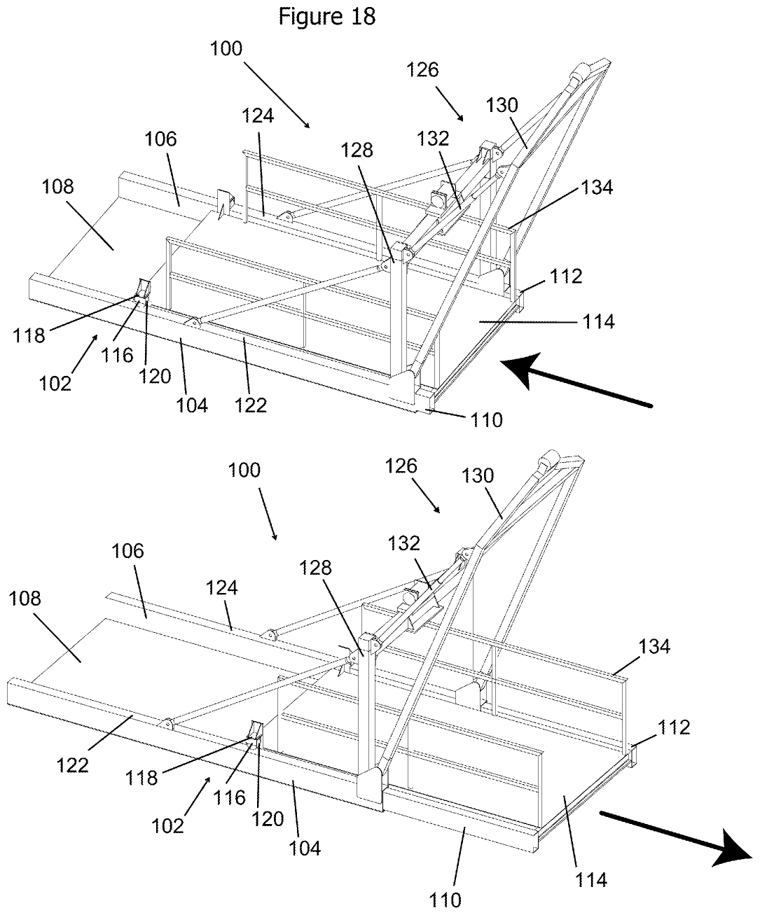

FIG. 18 is a perspective view of a deck and hoist in operation, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate 108 extending between said first box tube 104 and said second box tube 106; a first extension member 110 disposed within the first box tube 104 and being operable to retractably extend from the first box tube 104; a second extension member 112 disposed within the second box tube 106 and being operable to retractably extend from the second box tube 106; and a platform 114 having one or more wheel structures 116 located along one or more sides of the platform 114 and extending away therefrom, wherein the one or more wheel structures 116 are comprised of a wheel mount 118 and one or more wheels 120 and the one or more wheels 120 are configured to roll along a top surface 122 of the first box tube 104 and/or a top surface 124 of the second box tube 106, and wherein the platform 114 is operable to retractably extend at least partly beyond the edge of the floor in conjunction with the first extension member 110 and the second extension member 112.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In another embodiment, the deck 100 further includes, but is not limited to, a drive mechanism operable to extend and retract the at least one extension member 110, 112. Examples of such drive mechanism may include, but are not limited to, a hydraulic cylinder, chain motor, self-propelled wheel and/or gear motor, or a combination thereof. The platform 114 may also further comprise one or more wheels for interfacing directly or indirectly with the floor, or that interface directly with the stationary support structure 102 or bottom plate 108.

In another embodiment, the deck 100 further includes, but is not limited to, at least one guard rail 134 associated with the platform 114.

In another embodiment, the hoist 126 includes, but is not limited to, a winch; a sheave; a cable that extends from the winch over the sheave; and an overhaul ball coupled to the cable.

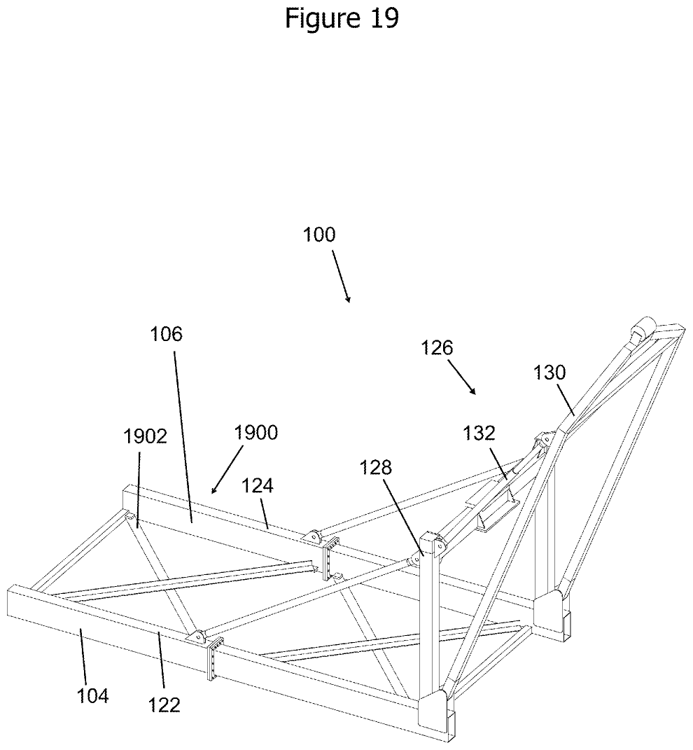

FIG. 19 is a perspective view of a hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units 1900 that can be combined to increase the length and/or area of the stationary support structure 1900, and/or make it easier to transport in smaller pieces. For example, the stationary support structure 1900 may be comprised of a number of square brackets with support beams 1902 attached at two adjacent corners of the brackets and extending to the middle of the side of the bracket opposite the corner's shared side.

The support units 1900 may be coupled together utilizing a variety of means including, but not limited to, bolts 1904, a clasp, a clamp, or similar means of securing them together. In some embodiments the support units 1900 may be configured to interlock when placed on a floor.

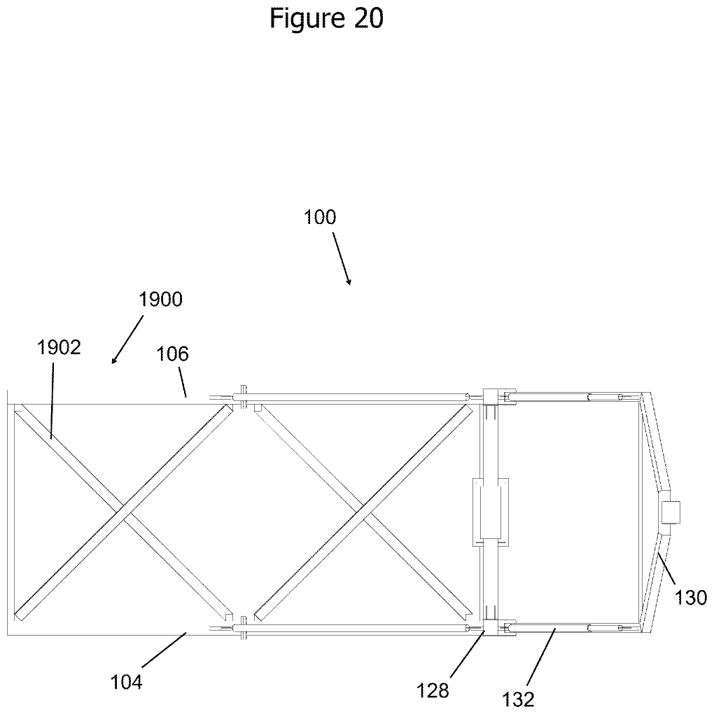

FIG. 20 is a top view of a hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface of the first box tube 104 and/or a top surface of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units 1900 that can be combined to increase the length and/or area of the stationary support structure 1900, and/or make it easier to transport in smaller pieces. For example, the stationary support structure 1900 may be comprised of a number of square brackets with support beams 1902 attached at two adjacent corners of the brackets of square brackets with support beams 1902 attached at two adjacent corners of the brackets and extending to the middle of the side of the bracket opposite the corner's shared side.

The support units 1900 may be coupled together utilizing a variety of means including, but not limited to, bolts 1904, a clasp, a clamp, or similar means of securing them together. In some embodiments the support units 1900 may be configured to interlock when placed on a floor.

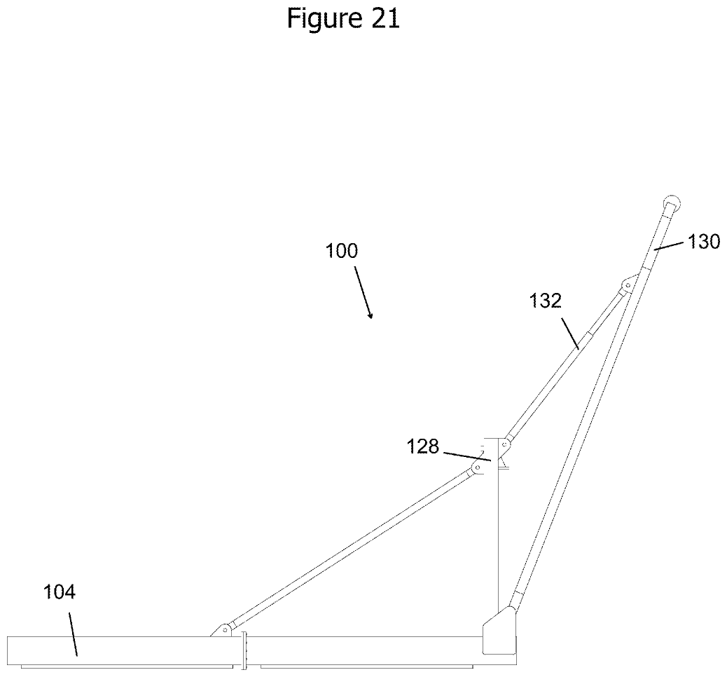

FIG. 21 is a side view of a hoist, in accordance with an embodiment of the invention.

A deck 100 for use in construction, the deck 100 comprising: a stationary support structure 102 including at least a first box tube 104 and a second box tube disposed parallel to the first box tube 104, the stationary support structure 102 being positionable entirely within an edge of a floor of a building; a bottom plate extending between said first box tube 104 and said second box tube; a first extension member disposed within the first box tube 104 and being operable to retractably extend from the first box tube 104; a second extension member disposed within the second box tube and being operable to retractably extend from the second box tube; and a platform having one or more wheel structures located along one or more sides of the platform and extending away therefrom, wherein the one or more wheel structures are comprised of a wheel mount and one or more wheels and the one or more wheels are configured to roll along a top surface of the first box tube 104 and/or a top surface of the second box tube, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units that can be combined to increase the length and/or area of the stationary support structure, and/or make it easier to transport in smaller pieces. For example, the stationary support structure may be comprised of a number of square brackets with support beams attached at two adjacent corners of the brackets.

The support units may be coupled together utilizing a variety of means including, but not limited to, bolts 1904, a clasp, a clamp, or similar means of securing them together. In some embodiments the support units may be configured to interlock when placed on a floor.

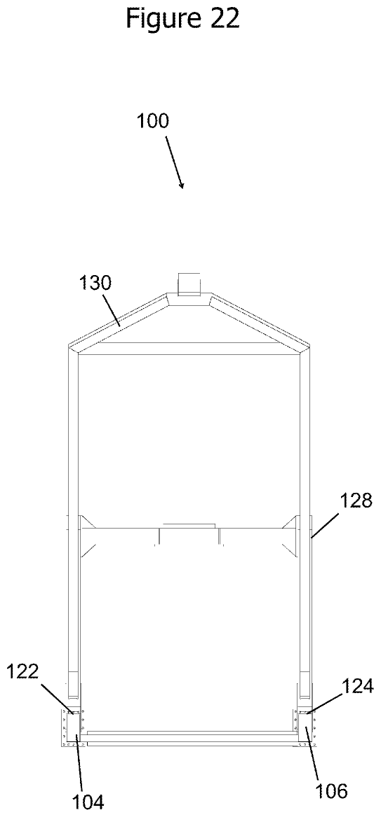

FIG. 22 is a front view of a hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device that extends from the mast 128 to the at least one boom 130 for adjusting pitch or angle of the at least one boom 130. In another embodiment, the deck 100 further includes, but is not limited to, a luffing device including at least one of a hydraulic cylinder or a cable. In such embodiments the cylinder or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units that can be combined to increase the length and/or area of the stationary support structure, and/or make it easier to transport in smaller pieces. For example, the stationary support structure may be comprised of a number of square brackets with support beams 1902 attached at two adjacent corners of the brackets.

The support units may be coupled together utilizing a variety of means including, but not limited to, bolts 1904, a clasp, a clamp, or similar means of securing them together. In some embodiments the support units may be configured to interlock when placed on a floor.

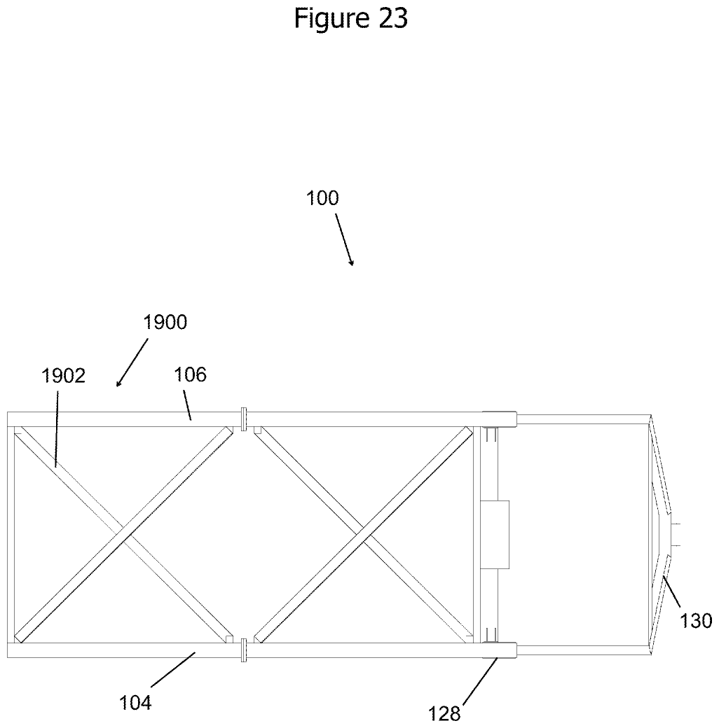

FIG. 23 is a bottom view of a hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface of the first box tube 104 and/or a top surface of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device that extends from the mast 128 to the at least one boom 130 for adjusting pitch or angle of the at least one boom 130. In another embodiment, the deck 100 further includes, but is not limited to, a luffing device including at least one of a hydraulic cylinder or a cable. In such embodiments the cylinder or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units 1900 that can be combined to increase the length and/or area of the stationary support structure 1900, and/or make it easier to transport in smaller pieces. For example, the stationary support structure may be comprised of a number of square brackets with support beams 1902 attached at two adjacent corners of the brackets.

The support units 1900 may be coupled together utilizing a variety of means including, but not limited to, bolts 1904, a clasp, a clamp, or similar means of securing them together. In some embodiments the support units 1900 may be configured to interlock when placed on a floor.

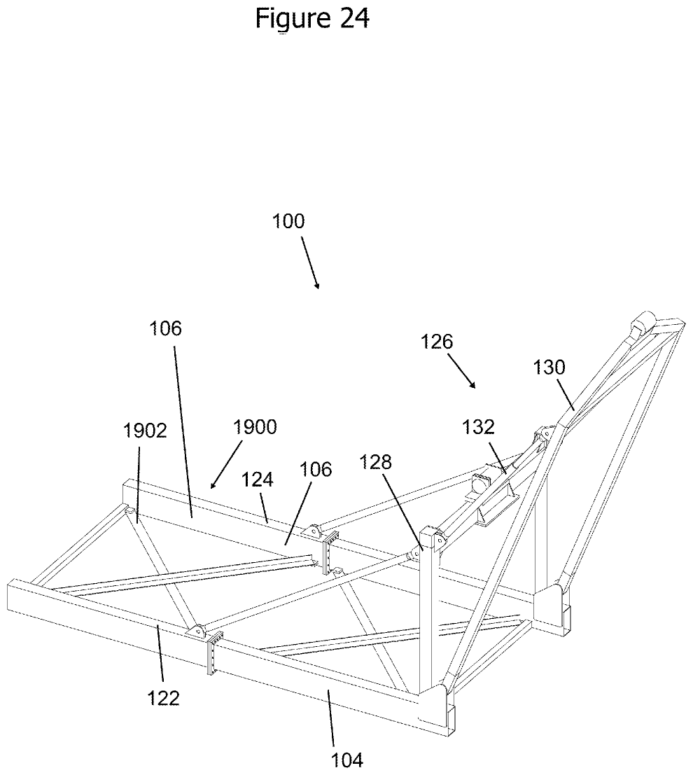

FIG. 24 is a perspective view of a hoist, in accordance with an embodiment of the invention.

A deck 100 for use in construction, the deck 100 comprising: a stationary support structure 102 including at least a first box tube 104 and a second box tube 106 disposed parallel to the first box tube 104, the stationary support structure 102 being positionable entirely within an edge of a floor of a building; a bottom plate extending between said first box tube 104 and said second box tube 106; a first extension member disposed within the first box tube 104 and being operable to retractably extend from the first box tube 104; a second extension member disposed within the second box tube 106 and being operable to retractably extend from the second box tube 106; and a platform having one or more wheel structures located along one or more sides of the platform and extending away therefrom, wherein the one or more wheel structures are comprised of a wheel mount and one or more wheels and the one or more wheels are configured to roll along a top surface 122 of the first box tube 104 and/or a top surface 124 of the second box tube 106, and wherein the platform is operable to retractably extend at least partly beyond the edge of the floor in conjunction with the first extension member and the second extension member.

In another embodiment, the deck 100 further includes, but is not limited to, a hoist 126 mounted on the stationary support structure 102 such that the hoist 126 is operable to project from inside the edge of the floor to a point beyond the edge of the floor for lifting one or more loads. In another embodiment, the deck 100 further includes, but is not limited to, a hoist 126 including at least a mast 128 mounted on the stationary support structure 102 and at least one boom 130 that projects from the mast 128 or the stationary support structure 102. In another embodiment, the deck 100 further includes, but is not limited to, a hoist 126 including at least a luffing device 132 that extends from the mast 128 to the at least one boom 130 for adjusting pitch or angle of the at least one boom 130. In another embodiment, the deck 100 further includes, but is not limited to, a luffing device 132 including at least one of a hydraulic cylinder or a cable. In such embodiments the cylinder 132 or cable may be the last structure before the hoist's 126 line, or it may be integrated into a stabilization structure for the hoist 126. In another embodiment, the deck 100 further comprises, but is not limited to, a hoist 126 that is removably mounted on the stationary support structure 102.

In some examples of the deck 100 and hoist 126, the deck 100 may be coupled to a stationary support structure 102 positionable on the floor of a building, and said support structure 102 may be comprised of a number of support units 1900 that can be combined to increase the length and/or area of the stationary support structure 1900, and/or make it easier to transport in smaller pieces. For example, the stationary support structure 1900 may be comprised of a number of square brackets with support beams 1902 attached at two adjacent corners of the brackets.

In some examples of the deck 100 and hoist 126, the deck 100 may be coupled to a stationary support structure 102 positionable on the floor of a building, and said support structure 102 may be comprised of a number of support units 1900 that can be combined to increase the length and/or area of the stationary support structure 1900, and/or make it easier to transport in smaller pieces. For example, the stationary support structure 1900 may be comprised of a number of square brackets with support beams 1902 attached at two adjacent corners of the brackets and extending to the middle of the side of the bracket opposite the corner's shared side.

In another embodiment, the hoist 126 includes, but is not limited to, a winch; a sheave; a cable that extends from the winch over the sheave; and an overhaul ball coupled to the cable.

The support units 1900 may be coupled together utilizing a variety of means including, but not limited to, bolts 1904, a clasp, a clamp, or similar means of securing them together. In some embodiments the support units 1900 may be configured to interlock when placed on a floor.

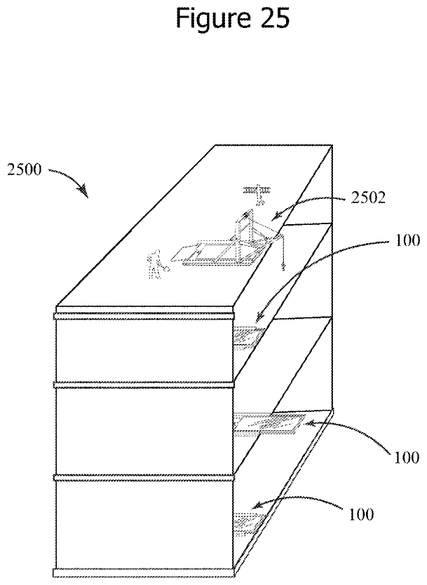

FIG. 25 is a perspective view of a set of decks and hoists in use in a building under construction, in accordance with an embodiment of the invention.

In FIG. 25 we see a perspective view of building under construction 2500 having multiple decks 100 on different floors, in accordance with an embodiment of the invention. Any of the decks 100 may include any of the features disclosed herein. For instance, deck 2502 includes a hoist, which enables lifting of loads onto and from itself, but also lifting of loads onto and from any of the decks 100. Thus, the hoist of deck 2502 can lift a load from itself or from any of decks 100 and lower or raise the load to any other deck or to the ground. Likewise, the hoist of deck 2502 can lift a load from the ground and deliver the load to itself or any other deck 100. Thus, no separate crane is required. However, a crane or another independent lifting device may also lift loads onto, from, or between any of the decks 100.

Additionally, the decks 100 are independently extendable and/or retractable from a floor edge. Thus, the decks 100 can be retracted completely or partially inside a floor edge when not in use or when being loaded, thereby eliminating and/or reducing interference of the deck 100 with movement of loads by one or more machines (e.g., deck 2502). Likewise, the hoist of deck 2502 is also positioned inside a floor edge with the exception of a boom and sheave so as to eliminate and/or reduce interference of the hoist with movement of loads by one or more machines (e.g., a crane or other lifting device). Note that the boom and sheave of deck 2502 can be further retracted so as to eliminate and/or reduce interference using a luffing device.

The decks 100 can carry increased weight on their respective platforms when extended past a floor edge because wheels located in the aft part of the platform distribute weight from the platform directly or indirectly to the floor. Counterweights can also be added to further increase the weight limits. These features enable the decks 100 to be used without shore posts or with less reliance on shore posts, which is beneficial when overlying structures are relatively weak (e.g., wood) or when there is no overlying structure (e.g., when on a roof).

Although shown used on a building, any of the decks 100 may be used in other contexts such as over a hole, over a side of a finished building, over a side of a boat or ship, in a manufacturing setting, in a retails setting, or any other location where it would be useful to raise, lower, extend, deliver, and/or receive loads.

Accordingly, the scope of the invention is not limited by the disclosure of these preferred and alternate embodiments. Instead, the invention should be determined by reference to the claims that follow.

What is claimed is:

1. A deck for use in construction, the deck comprising:
a stationary support structure including at least a first box tube and a second box tube disposed parallel to the first box tube, the stationary support structure being positionable entirely within an edge of a floor of a building;
a bottom plate extending between said first box tube and said second box tube;
a first extension member disposed within the first box tube and being operable to retractably extend from the first box tube;
a second extension member disposed within the second box tube and being operable to retractably extend from the second box tube; and
a platform having one or more wheel structures located along one or more sides of the platform, wherein the one or more wheel structures are comprised of a wheel mount and one or more wheels and the one or more wheels are configured to roll along a top surface of the first box tube and/or a top surface of the second box tube, and wherein the platform is operable to retractably extend at least partly beyond the edge of the floor in conjunction with the first extension member and the second extension member.

2. The deck of claim 1, wherein the one or more wheels of the one or more wheel structures are configured to roll on an inner half of the top surface of the first box tube and second box tube.

3. The deck of claim 1, further comprising:
a drive mechanism operable to extend and retract the at least one extension member.

4. The deck of claim 3, wherein the drive mechanism comprises at least one of: a hydraulic cylinder, a chain, or a self-propelled wheel.

5. The deck of claim 2, further comprising:
at least one shore post that extends from the stationary support structure.

6. The deck of claim 2, further comprising:
at least one counterweight receptacle coupled to the stationary support structure that is operable to removably receive one or more counterweights.

7. The deck of claim 4, further comprising:
one or more removable counterweights.

8. The deck of claim 2, further comprising:
a fold-away ramp coupled to the stationary support structure that is operable to facilitate transfer of one or more loads with respect to the platform.

9. The deck of claim 2, further comprising:
at least one guard rail associated with the platform.

10. The deck of claim 2, further comprising:
a hoist mounted on the stationary support structure such that the hoist is operable to project from inside the edge of the floor to a point beyond the edge of the floor for lifting one or more loads.

11. The deck of claim 10, wherein the hoist operable to project from inside the edge of the floor to a point beyond the edge of the floor comprises:
a mast mounted on the stationary support structure; and
at least one boom that projects from the mast or the stationary support structure.

12. The deck of claim 11, further comprising:
a luffing hydraulic cylinder that extends from the mast to the at least one boom for adjusting pitch or angle of the at least one boom.

13. The deck of claim 10, wherein the hoist further comprises:
a winch;
a sheave;
a cable that extends from the winch over the sheave; and
an overhaul ball coupled to the cable.

14. The deck of claim 10, wherein the hoist is height adjustable relative to the stationary support structure.

15. The deck of claim 10, wherein the hoist is position adjustable along a length of the stationary support structure.

16. The deck of claim 10, wherein the hoist is removably mounted on the stationary support structure.

17. A hoist for use in construction, the deck comprising:
one or more stationary support structure modules including at least a first box tube, a second box tube disposed parallel to the first box tube, and one or more support cross-beams, the one or more stationary support structure modules being configured to removably couple to each other to create a combined support structure being positionable entirely within an edge of a floor of a building.
a hoist mounted on the combined support structure such that the hoist is operable to project from inside the edge of the floor to a point beyond the edge of the floor for lifting one or more loads.

18. The deck of claim 17, wherein the hoist further comprises:
a winch;
a sheave;
a cable that extends from the winch over the sheave; and
an overhaul ball coupled to the cable.

19. The deck of claim 17, wherein the one or more stationary support structure modules are comprised of a front support beam connecting a front end of the first box tube and a front end of the second box tube, a rear support beam connecting a far end of the first box tube and a far end of the second box tube, and there are two support cross beams.

20. The deck of claim 19, wherein one of the two support cross beams is coupled to the far end of the first box tube and the other of the two support cross beams is coupled to the far end of the second box tube, and the support cross beams meet in a middle point of the front support beam.
